(19) United States
(12) Patent Application Publication
(10) Pub. No.: US 2001/0003356 A1
(43) Pub. Date: Jun. 14, 2001

(54) Electromagnetic radiation detection device

(75) Inventors: Jean-Jacques Yon, Sassenage (FR); Andre Perez, Cordeac (FR); Corinne Vedel, Lumbin (FR)

Correspondence Address: OBLON, SPIVAK, McCLELLAND, MAIER & NEUSTADT, P.C., Fourth Floor, 1755 Jefferson Davis Highway, Arlington, VA, 22202, US

(73) Assignee: COMMISSARIAT A L'ENERGIE ATOMIQUE, Paris (FR)

(21) Appl. No.: 09/727,471

(22) Filed: Dec. 4, 2000

(30) Foreign Application Priority Data
Dec. 10, 1999 (FR) 99 15596

(51) Int. Cl. G01J 5/22

(52) U.S. Cl. 250/338.1; 250/332; 250/338.2; 250/338.3

(57) ABSTRACT

The invention relates to a device for the detection of electromagnetic radiation comprising at least two elementary detectors (Dij), each elementary detector (Dij) comprising a first conductive terminal (pija) and a second conductive terminal (pijb) for sampling an electric signal representative of the detected radiation. The detection device incorporates first means (Iija) for connecting or disconnecting a first conductive terminal of the elementary detector (pija) with respect to a first input terminal of a processing circuit and second means (Iijb) for connecting or disconnecting a second conductive terminal (pijb) of the detector (Dij) with respect to a second input terminal of the processing circuit (Tj).

The invention more particularly applies to the thermal detection of electromagnetic radiation.

### TECHNICAL FIELD AND PRIOR ART

The invention relates to an electromagnetic radiation detection device.

The invention more particularly relates to a device for detecting electromagnetic radiation which comprises at least two elementary detectors.

The invention is applied with particular advantage in the case where the elementary detectors are microbridge thermal detectors.

An electromagnetic radiation detector based on the principle of thermal detection is generally constituted by different subassemblies performing four functions essential to the detection of a radiation, namely a radiation absorption function, a temperature measuring function, a thermal insulation function and a signal processing function.

The absorption function makes it possible to convert the energy of the incident electromagnetic wave, which is characteristic of the observed scene, into a heating of a detection structure. The parameters characterizing this function are on the one hand the relative absorption Ar defining the radio of the incident radiation luminance to the luminance effectively absorbed by the absorbing structure and on the other the filling or space factor Fr, which is the ratio of the useful surface effectively participating in the heating of the detector to the total surface thereof.

Therefore the optimization of the absorption function essentially consists of making the parameters Ar and Fr of a maximum level.

The temperature measurement function is performed by a thermometer. The thermometer is an element whose electrical characteristic is sensitive to the temperature. The physical characteristic of the element can be the electrical resistivity of the material in the case of a resistive bolometer, the electrical conductivity for a semiconductor device, the residual polarization in the case of a pyroelectric detector, the dielectric constant in the case of a ferroelectric detector, etc.

The essential quality factors characterizing the thermometer function are on the one hand the relative variation of the physical quantity observed with the temperature and on the other the electronic noise superimposed on the useful electrical signal of the thermometer.

The relative variation of the physical quantity observed with the temperature is quantified by a temperature coefficient generally designated TC. For a resistive bolometer of resistance R, the coefficient TC is expressed by TC=ΔR/RΔT, in which ΔR is the variation of the resistance R over the temperature range ΔT. According to the formalism established by Hooge, the electronic noise contains a low frequency contribution called 1/f noise, whose amplitude is inversely proportional to the volume of the material used for producing the thermometer.

The optimization of the thermometer consists of making the coefficient TC maximum and the 1/f noise minimum, which generally leads to increasing the volume of the thermometer.

The thermal insulation function is e.g. implemented by placing the absorbing structure and the thermometer on a membrane suspended above a substrate in accordance with a structure normally called a microbridge. Such a structure makes it possible to minimize the mechanical links, which give rise to thermal leaks between the microbridge and the substrate.

These mechanical links are constituted on the one hand by a device for mechanically supporting the membrane and on the other by a thermal insulation device. In general, such mechanical links also make it possible to support the electrical interconnections of the thermometer.

The parameters characterizing the thermal insulation function of the detector are on the one hand the thermal insulation Rth which must be given a maximum level in order to improve the sensitivity of the detector and on the other hand the calorific capacity Cth constituted by the volume of the thermometer associated with the volume of the absorbing element.

The calorific capacity Cth translates the thermal inertia of the detector. In order to produce a sensitive, rapid detector, it is necessary to both increase the thermal insulation and decrease the volume of the thermometer. Such an optimization can be brought about by a thin film structure.

The signal processing function consists of converting the electrical signal delivered by the thermometer into a signal compatible with the operating system such as e.g. a camera. In the case of arrays or linear arrays of detectors, the processing function is generally fulfilled by an electronic circuit, which insulates and amplifies the electrical signal from each thermometer and delivers a video signal from the individual signals. It is then essential that the information from the different detectors does not undergo mixing.

In most applications, the processing function is implemented by a circuit positioned directly beneath the detector in order not to deteriorate the space factor of the component. To achieve this it is known to make use of hybridization methods employing metal balls or monolithic methods known to the expert as above IC.

FIGS. 1 and 2 diagrammatically show a geometrical location of the different functions necessary for the thermal detection of an electromagnetic wave. FIG. 1 is a plan view of an elementary thermal detector and FIG. 2 a plan view of a block of four elementary thermal detectors of a matrix or array structure thermal detector.

Zone 1 represents the location of the absorbing element and the thermometer corresponding to the active zone of the detector, which effectively collects the incident wave.

Zones 2 and 3 represent the location of the mechanical support and electrical connection elements to the processing circuit of the elementary detector. Zones 4 and 5 locate the thermal insulation devices of the detector.

Zones 2, 3, 4 and 5 do not participate in detection and consequently reduce the space available for implementing the absorbing element and the thermometer, which is disadvantageous from the standpoints of the space factor and the 1/f noise of the thermometer.

Different thermal detector types are known in the art.

Thus, European patent application EP-354 369 describes an array of uncooled, monolithic, infrared detectors constituted by bolometers produced on a silicon substrate. The bolometers are constituted by a stack of thin films of silicon oxide, titanium nitride, hydrogenated amorphous silicon, titanium nitride and silicon oxide. The titanium nitride forms the infrared absorber and the resistance contacts and the amorphous silicon the resistor with a high temperature coefficient. The resistor is suspended over the silicon substrate by metal interconnections and the associated processing circuit is implemented in the silicon substrate below the resistor.

U.S. Pat. Nos. 5,367,167 and 5,672,903 disclose microbridge infrared radiation detectors. The mechanical support and electrical interconnection devices of the microbridges are very voluminous and have a complex design.

An electrical interconnection attached to a metal element for connection to the substrate must be contacted with the detector by means of a contact opening made in the microbridge.

Such a structure leads to relatively low space factors. Moreover, as can be gathered from FIGS. 1 and 2, the space factor decreases with the need for having at least two zones (designated 2 and 3 in FIGS. 1 and 2) per elementary detector in order to permit the flow of an electrical current between the two terminals of the detector.

The French patent filed on Aug. 8, 1996 and published under no. 2 752 299 discloses a particular construction making it possible to reduce the volume occupied by the mechanical support and electrical interconnection devices. A mechanical support and electrical interconnection device is here obtained by the deposition and etching of at least one conductive material so as to form a pillar, which directly connects the detector electrode and the processing circuit. An elementary detector comprises two supporting devices, so that it is necessary to have two pillars per elementary detector.

According to the prior art, it is known to use a processing circuit in the form of a series architecture or in the form of a parallel architecture. In a processing circuit having a series architecture, the detectors are successively read in sequential manner by a single reading device. In a processing circuit with a parallel architecture, the detectors are grouped in packets and the detectors of a particular packet are simultaneously read by the same number of reading devices as there are detectors per packet.

An example of a processing circuit with a parallel architecture is shown in FIG. 3. The detector shown in FIG. 3 comprises 12 elementary detectors arranged in the form of a matrix or array of four rows and three columns. Each elementary detector of the same column Cj (j=1, 2, 3) has a first terminal connected to a first terminal of a switch K, whose second terminal is connected by a column bus Bj to a first input of a processing circuit CTj. The second terminals of the elementary detectors of the same column are interconnected and connected to a second input of the processing circuit CTj. The second terminal of the different processing circuits CTj constitutes an electrical reference, e.g. the earth or ground of the detection device. The reading of the elementary detectors takes place row by row by applying a control signal k to the switches of the same row. Such a structure comprises elementary detectors like those shown in FIG. 1. As stated hereinbefore, such a structure is prejudicial from the 1/f noise and space factor standpoints.

The invention does not suffer from the disadvantages of the aforementioned, prior art detectors.

### DETAILED DESCRIPTION OF THE INVENTION

Thus, the invention relates to a device for the detection of electromagnetic radiation comprising at least two elementary detectors, each elementary detector comprising a first conductive terminal and a second conductive terminal for sampling an electrical signal representative of the detected radiation, the detection devices comprising electrical connection means for connecting the first terminal and the second terminal of an elementary detector to a processing circuit of the electrical signal. The electrical connection means comprise first means for connecting or disconnecting the first terminal of the elementary detector with respect to a first input terminal of the processing circuit and second means for connecting or disconnecting the second terminal of the elementary detector with respect to a second input terminal of the processing circuit.

Advantageously, the first and second means permit a complete electrical insulation of each elementary detector.

It is then possible to implement supporting and electrical interconnection devices of the microbridges which are common to several elementary detectors. When the processing circuit collects the electrical signal delivered by a first elementary detector, the latter is then electrically insulated from the other detectors, which share with it the same mechanical support and electrical interconnection devices. Advantageously, there is no mixing of signals from the detectors sharing the same mechanical support and electrical interconnection devices.

The surface necessary for producing the mechanical support and electrical interconnection devices can be reduced in proportion to the number of detectors sharing these devices. This space gain can e.g. be utilized for lengthening the thermal insulation devices in the manner to be described hereinafter (cf. FIGS. 5 and 7). The space gain also makes it possible to increase the surface reserved for the absorbing element and the thermometer.

By increasing the surface occupied by the absorbing element, the space factor increases. This leads to a significant improvement in the detector sensitivity.

In the same way, by increasing the surface occupied by the thermometer, on the one hand there is a reduction to the amplitude of the 1/f noise (which proportionally increases the signal-to-noise ratio) and on the other the thermometer design constraints are relaxed, thus aiding its optimization.

The combining of the mechanical support and electrical interconnection devices also aids an axial symmetry of the detection devices, which are in the form of arrays of elementary detectors. Such an axial symmetry aids the mechanical strength of the microbridges, as well as the optimization of the rules for the design of the absorbing element and the thermometer.

### BRIEF DESCRIPTION OF THE DRAWINGS

Other features and advantages of the invention can be gathered from studying the preferred embodiment of the invention described hereinafter with reference to the attached drawings, wherein show:

FIG. 1 A plan view of a prior art, elementary thermal detector.

FIG. 2 A plan view of a block of four elementary thermal detectors of a thermal detector having an array structure according to the prior art.

FIG. 3 A thermal detector having an array structure according to the prior art.

FIG. 4 An electrical circuit diagram of the array structure thermal detector according to a first embodiment of the invention.

FIG. 5 A plan view of a block of six elementary thermal detectors of an array structure thermal detector according to the first embodiment of the invention.

FIG. 6 An electrical circuit diagram of the array structure thermal detector according to a second embodiment of the invention.

FIG. 7 A plan view of a block of six elementary thermal detectors of an array structure thermal detector according to the second embodiment of the invention.

FIG. 8 An electrical circuit diagram of a first thermal detector according to the second embodiment of the invention.

FIG. 9 An electrical circuit diagram of a first variant of the thermal detector according to the second embodiment of the invention.

FIG. 10 An electrical circuit diagram of a second variant of a thermal detector according to the second embodiment of the invention.

### DETAILED DESCRIPTION OF EMBODIMENTS OF THE INVENTION

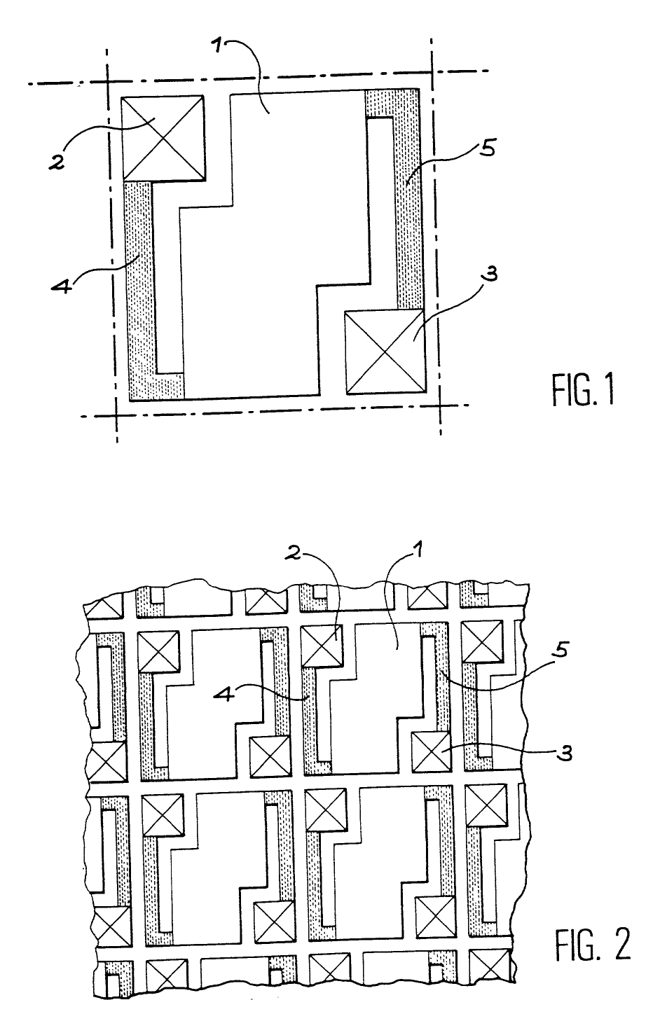

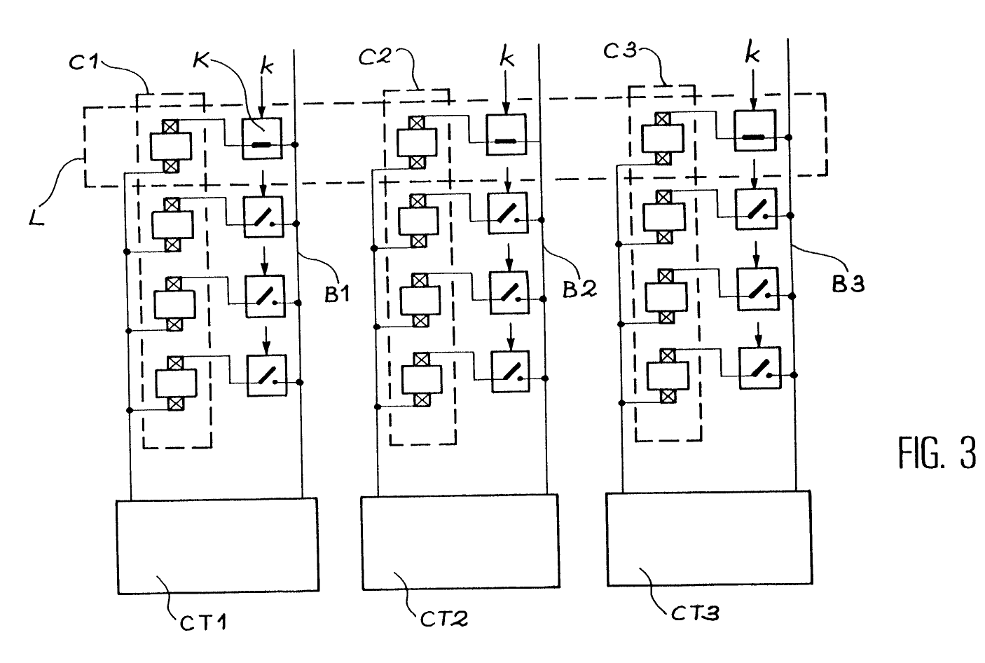

In all the drawings, the same references designate the same elements. As FIGS. 1, 2 and 3 have been described hereinbefore, there is no need to return to these.

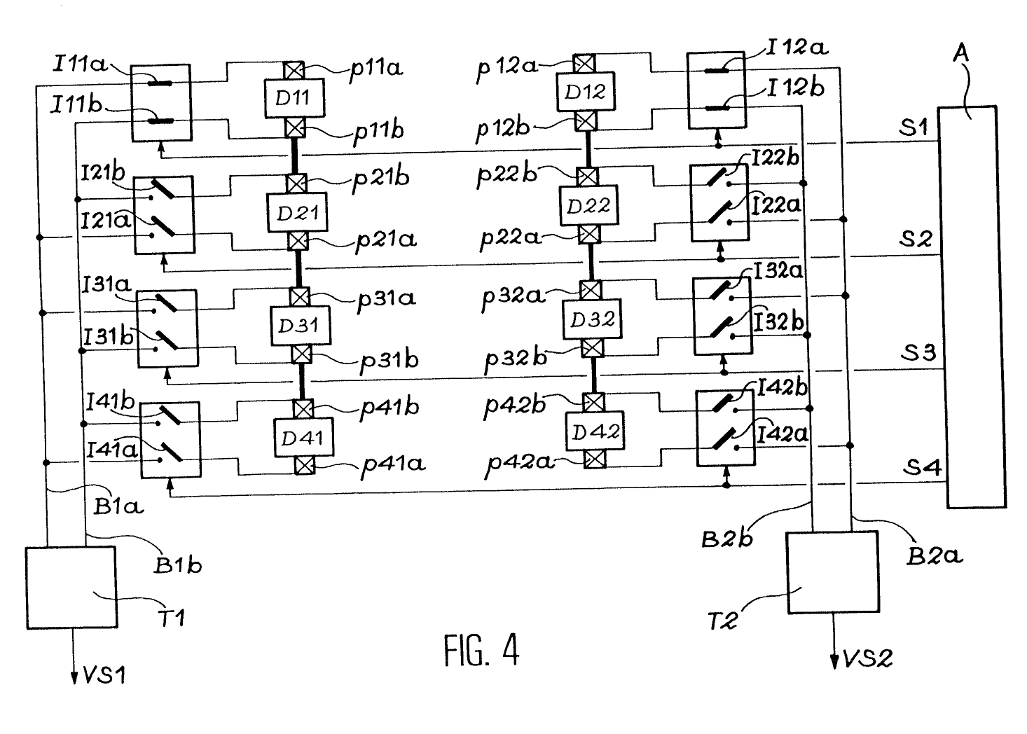

FIG. 4 is an electrical circuit diagram of the array structure thermal detector according to a first embodiment of the invention.

In the form of a non-limitative example, the thermal detector of FIG. 4 comprises eight elementary detectors in the form of a matrix or array of four rows and two columns. However, in general terms, the invention relates to a thermal detector having N×M elementary detectors arranged in the form of an array of N rows and M columns, M and N being integers. Each detector Dij (i=1, . . . , N and j=1, . . . , M) comprises a first conductive terminal pija and a second conductive terminal pijb for sampling the electrical signal delivered by the detector.

According to the invention, the first conductive terminal pija is connected to a first terminal of a first switch Iija, whose second terminal is connected to a first column bus Bja and the second conductive terminal pijb is connected to a first terminal of a second switch Iijb, whose second terminal is connected to a second column bus Bjb.

Each column bus Bja connecting all the second terminals of the switches Iija of the column of rank j is connected to a first input terminal of a processing circuit Tj. Each column bus Bjb connecting all the second terminals of the switches Iijb of the column of rank j is connected to a second input terminal of the processing circuit Tj. The second input terminal of the processing circuit Tj is an electrical reference terminal such as e.g. the earth or ground of the thermal detector. The processing circuit Tj delivers an output signal VSj.

The conductive terminals pija and pijb of the detector Dij are respectively connected to the conductive terminal pi+1ja of the detector Di+1j and to the terminal pi-1jb of the detector Di-1j.

An addressing device A simultaneously applies to the switches Iija and Iijb of the row of rank i the same control signal Si. All the switches associated with the elementary detectors of the same row are then controlled by the switch Si.

The operation of the detection device is based on the principle of a scan reading involving the simultaneous measurement of the elementary thermal detectors of the same row.

The different rows are preferably read in sequential manner. As a non-limitative example, FIG. 4 shows a configuration for which the first row is being read.

As stated hereinbefore, the conductive terminals pija and pijb of the detector Dij are respectively connected to the conductive terminal pi+1ja of the detector Di+1j and to the conductive terminal pi-1jb of the detector Di-1j. Advantageously, the conductive terminal pija of the detector Dij can then coincide with the conductive terminal pi+1ja of the detector Di+1j and the conductive terminal pijb of the detector Dij can coincide with the conductive terminal pi-1jb of the detector Di-1j.

According to the preferred embodiment of the invention, an elementary detector is a thermal detector comprising a microbridge and a device for supporting the microbridge. The microbridge supporting device comprises a first support element on which is placed the first conductive terminal pija and a second support element on which is placed the second conductive terminal pijb.

According to the embodiment shown in FIG. 4, the detectors of the same column are arranged in such a way that two adjacent detectors of the same column share the same support element and the same conductive terminal, the common support element shared by two adjacent detectors being alternately the first support element and the second support element.

The surface area necessary for producing the mechanical support and electrical interconnection devices of the complete detection device according to the invention is then reduced substantially by half compared with the surface area necessary for a prior art device. Thus, there is an improvement to the detector performance characteristics.

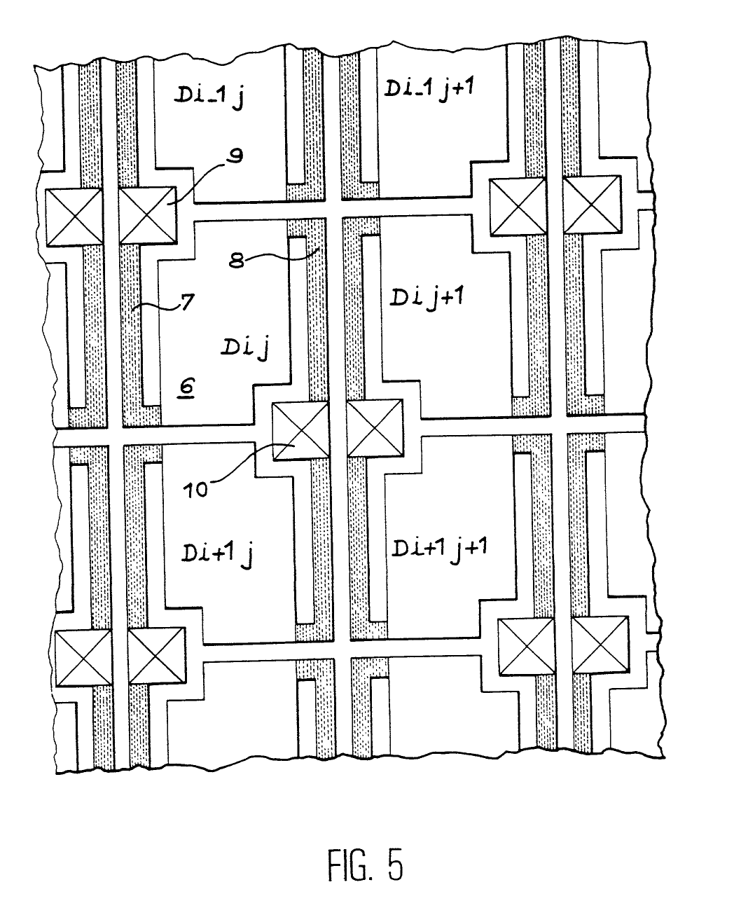

In exemplified manner, FIG. 5 shows a plan view of a block of six elementary thermal detectors of the array structure according to FIG. 4.

Each microbridge, elementary thermal detector Dij is constituted by a zone 6, where there are located the absorbing element and the thermometer, two thermal insulation zones 7 and 8 and two zones 9 and 10 each localizing a mechanical support and electrical interconnection device. Zone 9 localizes the mechanical support and electrical interconnection device common to the detectors Dij and Di-1j and zone 10 localizes the mechanical support and electrical interconnection device common to the detectors Dij and Di+1j.

The adjacent elementary detectors located on the same column are successively deduced by order 2 symmetry with respect to an axis perpendicular to the axis defined by the column. Advantageously, it is then possible to produce thermal insulation devices 8 of the same length for each detector.

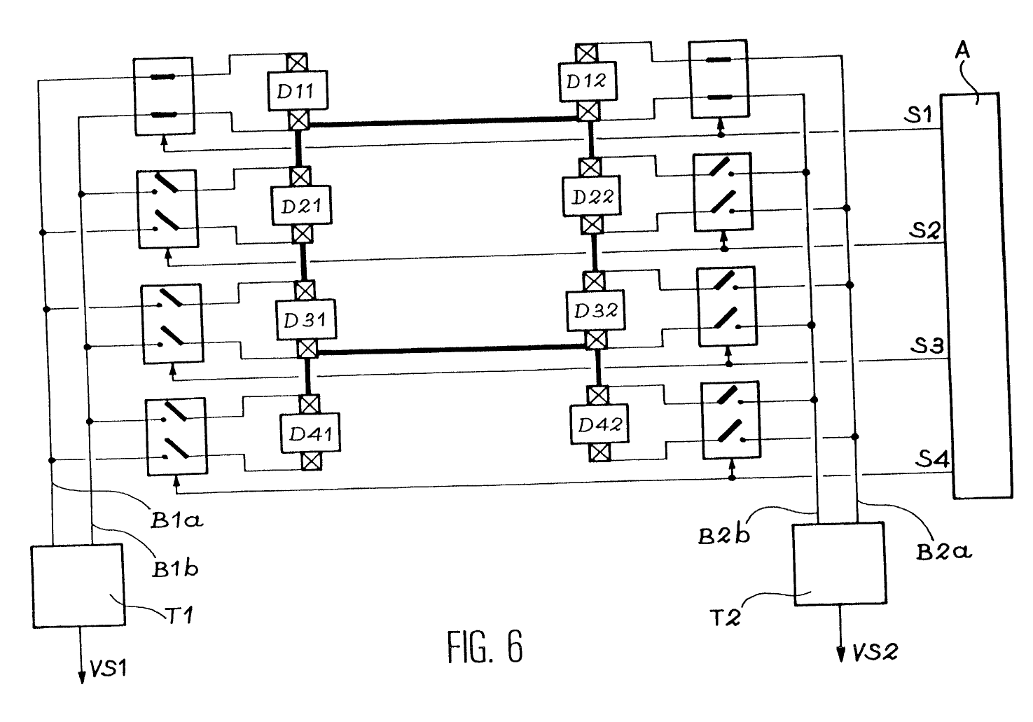

FIG. 6 is an electrical circuit diagram of the array structure thermal detector according to a second embodiment of the invention.

As hereinbefore, the thermal detector of FIG. 6 comprises in exemplified manner eight elementary detectors in the form of an array of four rows and two columns. In general terms, the second embodiment of the invention also relates to a thermal detector of N×M elementary detectors arranged in the form of an array of N rows and M columns, M and N being integers.

The device of FIG. 6 comprises the same elements as in the device of FIG. 4. According to the embodiment shown in FIG. 6, the conductive terminals p11b, p12b, p21b and p22b of the respective detectors D11, D12, D21 and D22 are interconnected and the conductive terminals p31b, p32b, p41b and p42b of the respective detectors D31, D32, D41 and D42 are interconnected.

According to the preferred embodiment of the invention for which an elementary detector is a thermal detector as indicated hereinbefore, the second support element common to two adjacent detectors of a column of odd rank j is common to the second support element common to the two adjacent detectors of the column of even rank j+1.

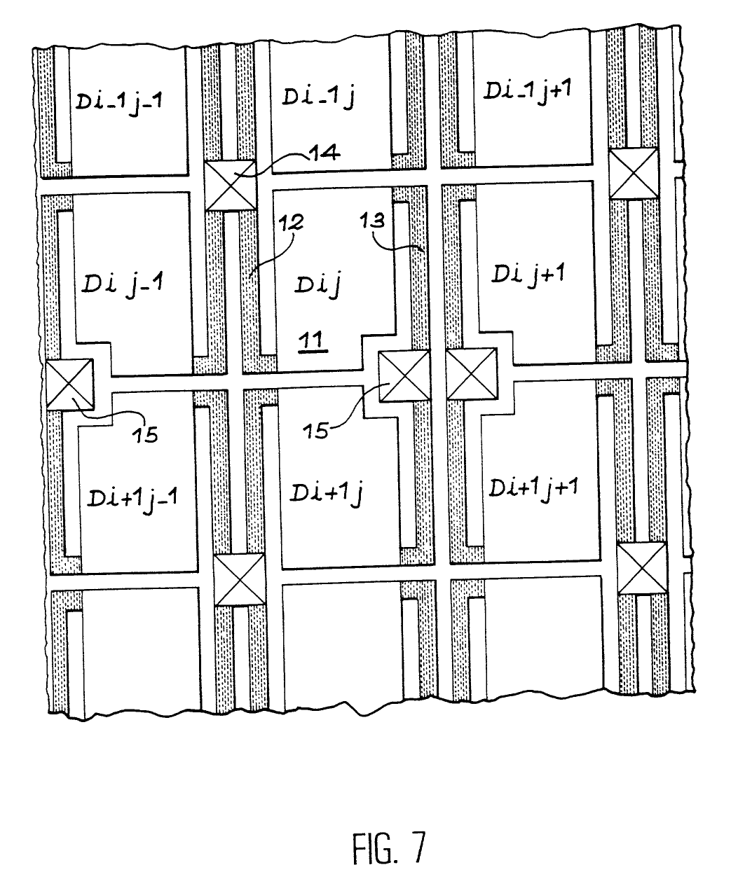

For illustration purposes, FIG. 7 is a plan view of a block of six elementary thermal detectors of the array structure according to FIG. 6.

Each microbridge, elementary thermal detector Dij is constituted by a zone 11 where installation takes place of the absorbing element and the thermometer, two thermal insulation zones 12 and 13 and two zones 14 and 15 in each case localizing a mechanical support and electrical interconnection element. Zone 15 localizes the first mechanical support and electrical interconnection element common to the detectors Dij and Di+1j and zone 14 localizes the second mechanical support and electrical interconnection element common to the detectors Di-1j-1, Di-1j, Dij and Dij-1.

Adjacent elementary detectors on the same column are successively deduced by order 2 symmetry with respect to an axis perpendicular to the axis defined by the column. Advantageously, it is then possible to implement thermal insulation devices 12 of the same length for each detector.

According to a preferred embodiment, the elementary thermal detectors, the connection means of the elementary thermal detectors to the processing circuits and the processing circuits are implemented on the same support. The elementary thermal detectors are positioned above the processing circuits in order to increase the detection capacities. The technology used can be the above IC technology referred to hereinbefore or hybridization technology using metal balls. The constituent elements of the processing circuits are then produced according to integrated circuit technology. As a non-limitative example, CMOS (the acronym CMOS standing for complimentary metal oxide semiconductor), BICMOS and bipolar technologies and other technologies derived therefrom can be used.

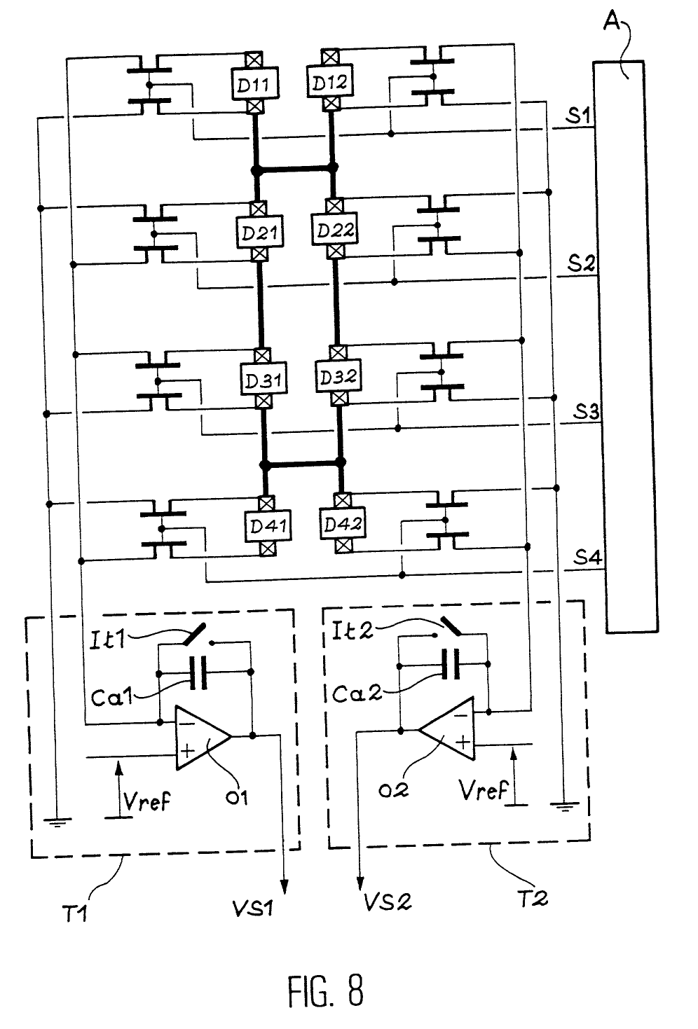

FIG. 8 is an electrical circuit diagram of a first example of a thermal detector according to the second embodiment of the invention.

According to the example illustrated in FIG. 8, the switches Iija and Iijb are implemented with the aid of MOS transistors operating either under off or ohmic conditions. It is also possible to implement said switches by using bipolar transistors. The addressing device A is a digital circuit stimulating at a given time a single row from among the rows to be scanned. The digital circuit can be implemented by a recirculating shift register formed from the same number of stages as there are rows to be addressed. Another solution consists of using a combinatorial logic demultiplexer of 2^{P} to P complexity, where P is equal to or greater than the number N of rows to be scanned.

Each processing circuit Tj (j=1, 2) comprises a measuring means, e.g. constituted by a capacitive feedback operational amplifier Oj, a capacitor Caj and a switch Itj. The capacitor Caj and the switch Itj are connected in parallel between the inverting input and the output of the operational amplifier Oj. The switch Itj is used for reinitializing the capacitor Caj between the reading of two successive rows. A reference voltage Vref is applied to the non-inverting input of the amplifier Oj.

According to the embodiment illustrated in FIG. 8, the operational amplifier is of the capacitive feedback type. The invention also relates to the case where the operational amplifier is of the resistive feedback type.

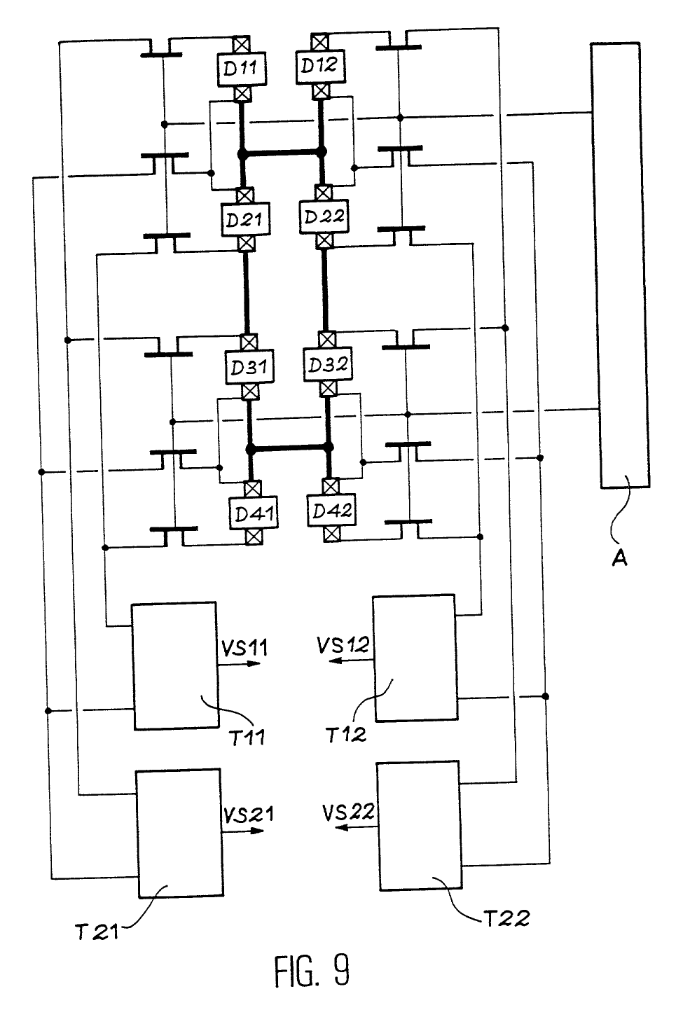

FIG. 9 shows an electric circuit diagram of a first variant of a thermal detector according to the second embodiment of the invention.

The thermal detector comprises two processing circuits per column of elementary detectors. It is then possible to simultaneously read two rows of elementary detectors.

As a non-limitative example, the even rows of elementary detectors are read by a first group of processing circuits (T11 and T12) and the odd rows by a second group of processing circuits (T21 and T22). Such a device then advantageously simultaneously reads two consecutive rows.

The switches of adjacent rows which are simultaneously processed are advantageously controlled by a single row control. The addressing device A generating the control signal then implements a 2^{U} to U decoder, in which U is equal to or higher than half the rows of detectors to be processed.

The switch having two transistors used in the device according to FIG. 8 is here advantageously replaced by a switch having a single transistor.

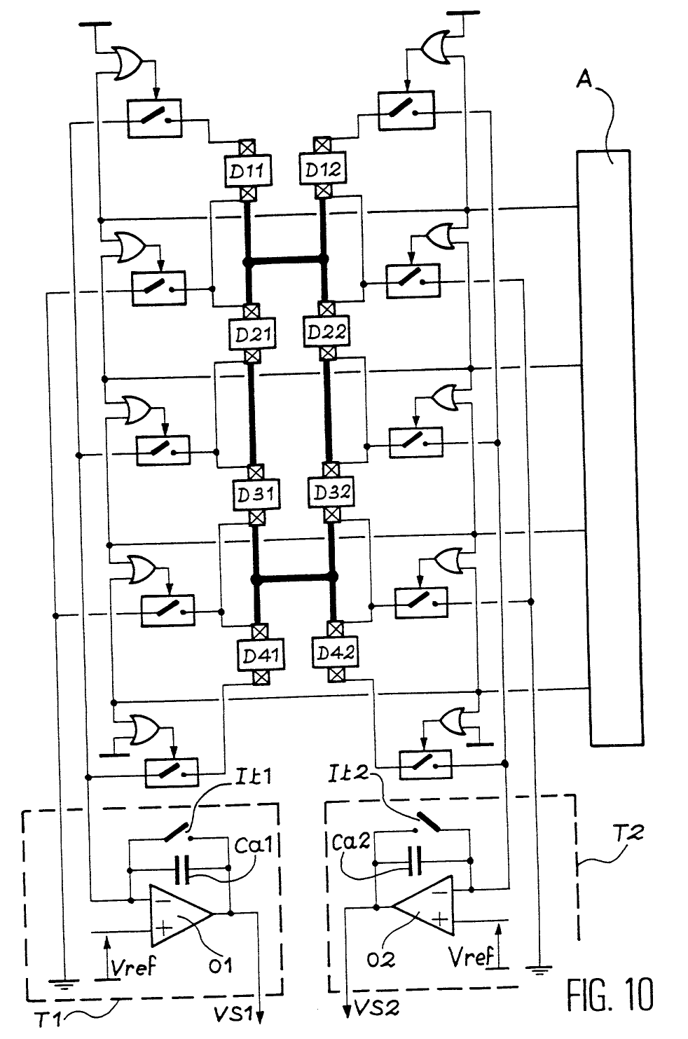

FIG. 10 shows an electric circuit diagram of a second thermal detector variant according to the second embodiment of the invention.

According to this second variant, the first means for connecting or disconnecting the first conductive terminal of an elementary detector with respect to the processing circuit are constituted by a switch and a logic OR circuit. In the same way, the second means for connecting or disconnecting the second conductive terminal of an elementary detector with respect to the processing circuit are also constituted by a switch and a logic OR circuit.

Advantageously, according to said second variant, the conductive terminals common to the two adjacent elementary detectors of the same column are connected to the same switch and to the same logic OR circuit. A logic OR circuit comprises two inputs and one output. One input of the logic OR circuit participating in the first means associated with an elementary detector is connected to an input of the logic OR circuit participating in the second means associated with said same elementary detector, the inputs being connected to the same control row. In addition, each switch is controlled by the output signal of the logic OR circuit associated therewith. Thus, as a function of the logic level of the signal applied to the inputs of the logic OR circuits, it is possible to simultaneously switch on or off the switches. In FIG. 10, the logic OR circuits are shown to be external of the addressing device A. Advantageously, the invention also relates to the case where the logic OR circuits are integrated into the addressing device.

According to the embodiments of the invention described hereinbefore, the number of processing devices is equal to or exceeds the number of columns of the detection device.

The invention also relates to cases where the number of processing devices is smaller than the number of columns of the detection device. In such a hypothesis, the same processing device is common to several columns and sequentially processes the elementary detectors of the different columns. In the extreme case, a single processing device can be used for all the elementary detectors of the same detection device.

In another variant of the invention, a processing device can comprise a measuring means (Oj, Caj, Itj) common to several elementary detectors and a different electrical reference point for each elementary detector.

As a result of minor modifications to the processing devices described hereinbefore, the invention can be applied to thermal detectors supplying a voltage. This is e.g. the case with resistive detectors polarized in current or by a resistor.

In addition to the microbridge bolometric detectors referred to hereinbefore, the invention also e.g. applies to diode detectors, pyroelectric detectors and ferroelectric detectors.

1. Device for the detection of electromagnetic radiation comprising at least two elementary detectors (Dij), each elementary detector (Dij) comprising a first conductive terminal (pija) and a second conductive terminal (pijb) for sampling an electrical signal representative of the detected radiation, the detection device comprising electrical connection means for connecting the first terminal (pija) and the second terminal (pijb) of an elementary detector (Dij) to a processing circuit (Tj) of the electrical signal, characterized in that the electrical connection means comprise first means (Iija) for connecting or disconnecting the first conductive terminal of the elementary detector (pija) with respect to a first input terminal of the processing circuit and second means (Iijb) for connecting or disconnecting the second conductive terminal (pijb) of the detector (Dij) with respect to a second input terminal of the processing circuit (Tj).

2. Device for the detection of electromagnetic radiation according to claim 1, characterized in that each elementary detector (Dij) is a thermal detector comprising a microbridge and a device for supporting the microbridge comprising a first support element on which is located the first conductive terminal (pija) and a second support element on which is located the second conductive terminal (pijb).

3. Device for the detection of electromagnetic radiation according to either of the claims 1 and 2, characterized in that it is arranged in the form of an array of N rows×M columns of elementary thermal detectors, the detectors of the same column being arranged in such a way that two adjacent detectors of the same column share the same support element and the same conductive terminal, the common support element shared by the two adjacent detectors being alternately a first support element or a second support element.

4. Device for the detection of electromagnetic radiation according to claim 3, characterized in that the second support element common to two adjacent detectors of a column of odd rank j is common to the second support element common to two adjacent detectors of the column of even rank j+1.

5. Device for the detection of electromagnetic radiation according to claim 1, characterized in that the first means are constituted by a first switch and the second means by a second switch, the first and second switches being controlled by the same control signal.

6. Device for the detection of electromagnetic radiation according to claim 3, characterized in that in each case the first and second means are constituted by a switch and a logic OR circuit, the logic OR circuit of the first means having an input connected to an input of the logic OR circuit of the second means, said inputs being connected to the same control row, each switch being controlled by the output signal of the logic OR circuit associated therewith.

7. Device for the detection of electromagnetic radiation according to claim 3, characterized in that it comprises one processing circuit per column of detectors for simultaneously reading the detectors of the same row.

8. Device for the detection of electromagnetic radiation according to claim 3, characterized in that it comprises at least two processing circuits per column for simultaneously reading the detectors of at least two rows.

9. Device for the detection of electromagnetic radiation according to claim 3, characterized in that it comprises the same processing circuit for several columns so as to sequentially read the detectors of different columns.

10. Device for the detection of electromagnetic radiation according to claim 3, characterized in that it comprises a single processing circuit for all the detectors of the array.

11. Device for the detection of electromagnetic radiation according to claim 5, characterized in that the switches are bipolar or MOS transistors.

12. Device for the detection of electromagnetic radiation according to claim 1, characterized in that the elementary detectors are bolometric detectors or diode detectors or pyroelectric detectors or ferroelectric detectors.
